(19) United States
(12) Patent Application Publication
(10) Pub. No.: US 2001/0048481 A1
(43) Pub. Date: Dec. 6, 2001

(54) Broadcasting system, transmitter, and receiver

(75) Inventors: Hiroshi Hatano, Osaka (JP); Hideki Nagata, Kobe-Shi (JP); Akira Kawabata, Ikoma-Shi (JP)

Correspondence Address: MCDERMOT, WILL & EMERY, 600 13th Street, N.W., Washington, DC, 20005, US

(73) Assignee: MINOLTA CO., LTD.

(21) Appl. No.: 09/860,609

(22) Filed: May 21, 2001

(30) Foreign Application Priority Data
May 24, 2000 (JP) P2000-153191

(51) Int. Cl. H04N 7/08; H04N 9/74

(52) U.S. Cl. 348/473; 348/584

(57) ABSTRACT

In so-called multi-angle broadcasting for broadcasting one program by using a plurality of broadcast channels, attendant information is transmitted which indicates the composite display position and the size of a video picture. A receiver produces a composite display of the video picture in accordance with the attendant information. This produces, for example in an automobile racing program, a composite display of video pictures of respective cars in combination with a video picture of the entire racing course in accordance with the positions of the respective cars racing along the race course, to allow a viewer to enjoy viewing the positions of the respective cars and the video pictures of the respective cars at the same time.

This application is based on application No. 2000-153191 filed in Japan, the contents of which are hereby incorporated by reference.

### BACKGROUND OF THE INVENTION

1. Field of the Invention

The present invention relates to a technique of transmitting and receiving a broadcast of a single program.

2. Description of the Background Art

Advances in digital broadcasting technology have made it possible to significantly increase the number of broadcast channels receivable by receivers. On the other hand, a variety of unprecedented methods of viewing and listening to broadcast programs have been proposed by the use of a multiplicity of channels.

One of the methods of more usefully viewing and listening to broadcast programs by the use of a multiplicity of channels is a technique of broadcasting various video pictures regarding one program by the use of a plurality of broadcast channels. The use of such broadcasting technique allows a viewer to select a channel to enjoy a favorite video picture. In the same baseball game program, for example, broadcasting a video picture captured to show only one of the teams and a video picture captured to show only the other team by the use of different channels allows a viewer who supports any one of the teams to select a channel to more enjoy viewing and listening to the program.

### SUMMARY OF THE INVENTION

The present invention is intended for a transmitter for transmitting a broadcast signal for one program by using a plurality of broadcast channels.

According to the present invention, the transmitter comprises: a section for generating program information including information about a plurality of video pictures corresponding to the plurality of broadcast channels; a section for generating position information about a position in which at least one video picture included among the plurality of video pictures is to be displayed on a display screen of a receiver; and a section for transmitting the position information together with the program information.

This allows control of the display position of a video picture by using the transmitted position information, to provide a new form of viewing and listening to the program.

According to an aspect of the present invention, the section for generating the position information generates position information about a position in which at least two video pictures included among the plurality of video pictures are to be displayed on the display screen of the receiver. The transmitter further comprises a section for generating information indicating display priorities of the at least two video pictures for use when the at least two video pictures overlap each other. The section for transmitting the position information transmits the information indicating the display priorities together with the program information and the position information.

This allows proper control of display of the video pictures which overlap each other.

According to another aspect of the present invention, the position information changes with time in accordance with contents of the program.

This allows control of the display position of a video picture in accordance with the contents of the program.

The present invention is also intended for a receiver for receiving a broadcast signal for one program using a plurality of broadcast channels, and for a broadcasting system comprising a transmitter and a receiver.

It is therefore an object of the present invention to provide a technique of broadcasting one program by using a plurality of channels, which is capable of providing to a viewer a plurality of video pictures enjoyable in a new way by using the plurality of video pictures more effectively.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a schematic construction of a broadcasting system;

FIG. 2 is a block diagram showing a construction of a transmitter;

FIG. 3 is a flow diagram showing the operation of the transmitter;

FIGS. 4A through 4D show examples of a plurality of video pictures transmitted from the transmitter;

FIG. 5 is a block diagram showing a construction of attendant information;

FIG. 6 is a block diagram showing a construction of a receiver;

FIG. 7 is a block diagram showing a construction of an output control circuit with flows of signals and information;

FIG. 8 is a flow diagram showing the operation of the receiver for video picture display;

FIG. 9 is a block diagram showing flows of signals and information when absolute position information and size information are used;

FIG. 10 shows an example of a display produced on a display screen when the absolute position information and the size information are used;

FIG. 11 shows an example of a display produced on the display screen when the absolute position information, the size information and priority information are used;

FIG. 12 shows an example of a display produced on the display screen when information about rotation is used;

FIG. 13 is a block diagram showing flows of signals and information when reference position information and the absolute position information are used;

FIGS. 14 and 15 show examples of displays produced on the display screen when the reference position information and the absolute position information are used;

FIG. 16 is a block diagram showing another example of flows of signals and information when the reference position information and the absolute position information are used;

FIGS. 17 and 18 shows other examples of displays produced on the display screen when the reference position information and the absolute position information are used;

FIGS. 19 through 21 shows examples of displays in a different program;

FIG. 22 shows an example of a video picture transmitted from the transmitter;

FIG. 23 shows an example of a video picture including sub-video pictures transmitted from the transmitter;

FIG. 24 is a block diagram showing a construction of the attendant information;

FIG. 25 is a block diagram of a construction of the output control circuit with flows of signals and information; and

FIGS. 26 and 27 show examples of displays produced on the display screen.

### DESCRIPTION OF THE PREFERRED EMBODIMENTS

1. First Preferred Embodiment

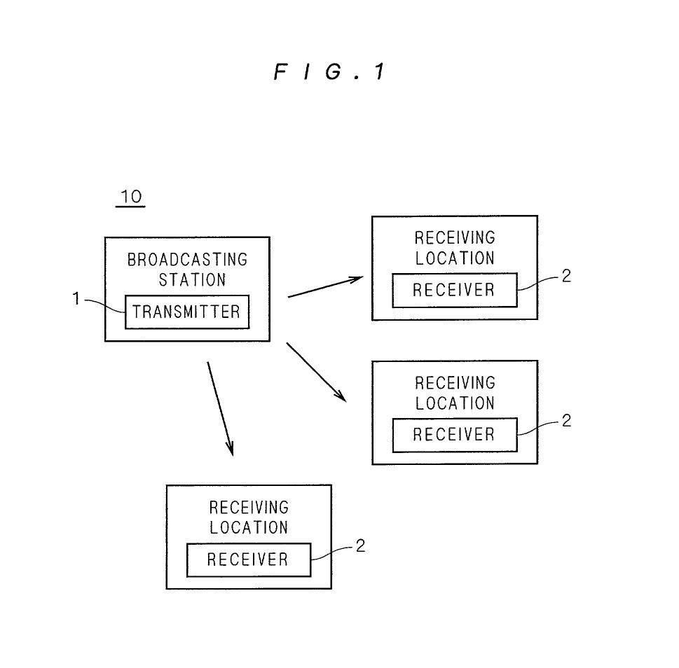

FIG. 1 is a schematic block diagram showing a construction of a broadcasting system 10 according to a first preferred embodiment of the present invention. In the broadcasting system 10, radio waves are transmitted from a transmitter 1 in a broadcasting station and are then received by receivers 2 in respective receiving locations such as homes and offices so that video and voice are outputted from a display and a loudspeaker connected to each of the receivers 2 (or included in each of the receivers 2). Transmission from the transmitter 1 may be provided by any scheme, for example, satellite broadcasting and cable broadcasting schemes in addition to terrestrial broadcasting schemes.

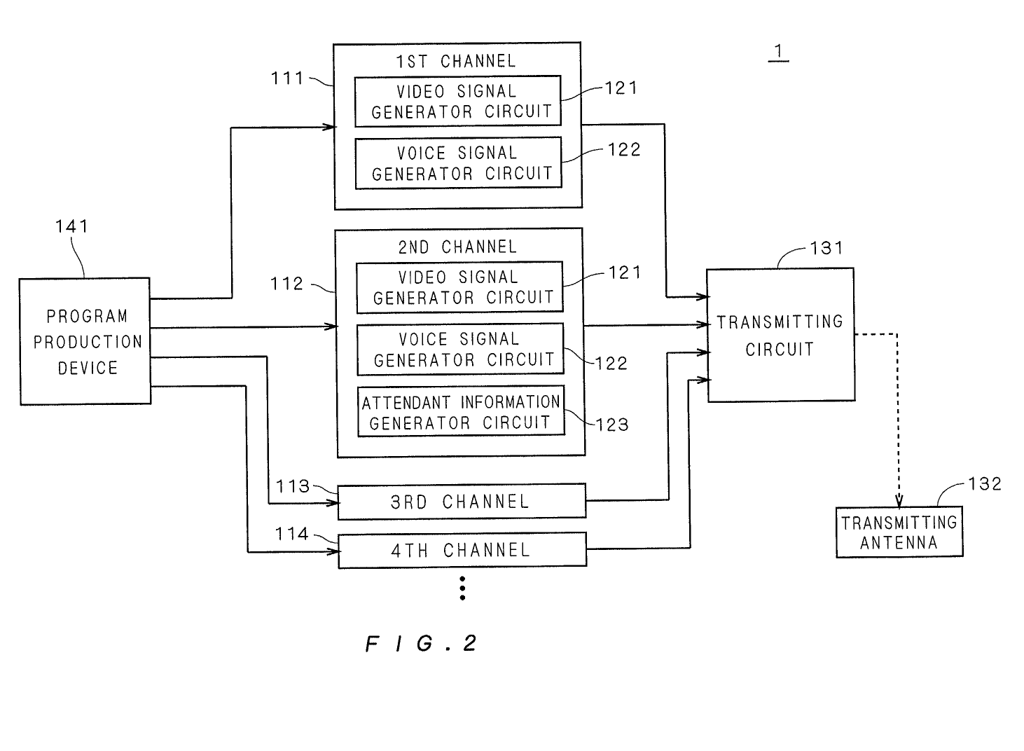

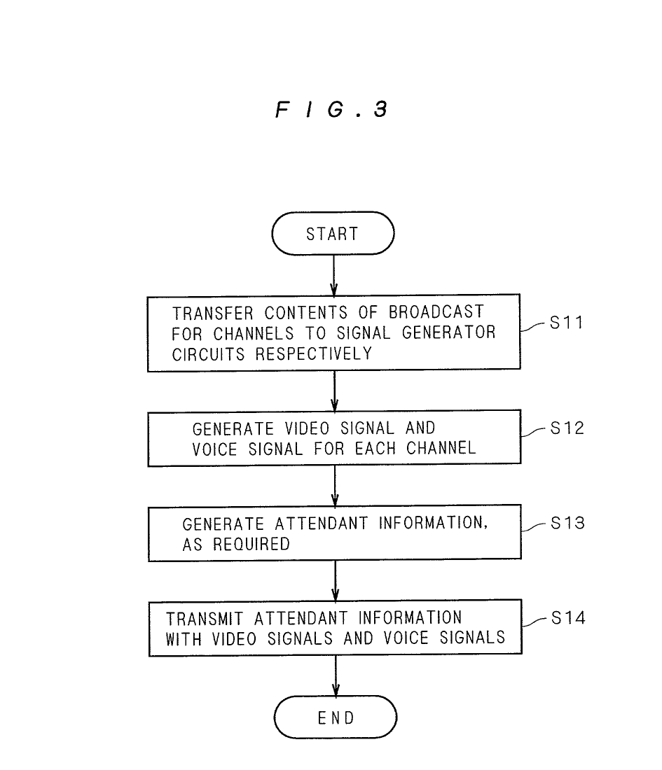

FIG. 2 is a block diagram showing a construction of the transmitter 1. FIG. 3 is a flow diagram showing the operation of the transmitter 1. The steps shown in FIG. 3 are performed substantially in parallel during broadcasting, but are shown in the form of a flow diagram for purposes of convenience. The transmitter 1 will be described with reference to FIGS. 2 and 3.

The transmitter 1 is capable of transmitting a broadcast signal for one program by using a plurality of broadcast channels, and comprises a plurality of signal generator circuits for generating signals (referred to hereinafter as “channel signals”) for respective channels, and a transmitting circuit 131 for transmitting the broadcast signal including the plurality of channel signals. In FIG. 2, the reference numerals 111, 112, 113 and 114 designate first to fourth channel signal generator circuits, respectively, among the multiplicity of signal generator circuits.

A program production device 141 transfers the contents of the broadcast for the channels to the signal generator circuits, respectively (Step S11). Each of the signal generator circuits comprises a video signal generator circuit 121 and a voice signal generator circuit 122, and generates a channel signal including a video signal and a voice signal (Step S12). As a result, these circuits generate a program information signal including a plurality of video signals.

More specifically, the program production device 141 transfers the contents of the broadcast for a first channel to the first channel signal generator circuit 111 which in turn generates a video signal and a voice signal. The program production device 141 transfers the contents of the broadcast for a second channel to the second channel signal generator circuit 112 which in turn generates a video signal and a voice signal.

The second channel signal generator circuit 112 further comprises an attendant information generator circuit 123 for generating attendant information about the display position, the size and the like of a video picture for the second channel on a display screen of the receiver 2 (Step S13). The generated attendant information is included in the channel signal.

The third and subsequent channel signal generator circuits are similar to the second channel signal generator circuit 112, and each generate a channel signal including a video signal, a voice signal and attendant information.

The transmitter 1 having such a construction transmits the broadcast signal from the transmitting circuit 131 via a transmitting antenna 132 to send out the attendant information with the program information signal including the plurality of video signals and voice signals (Step S14).

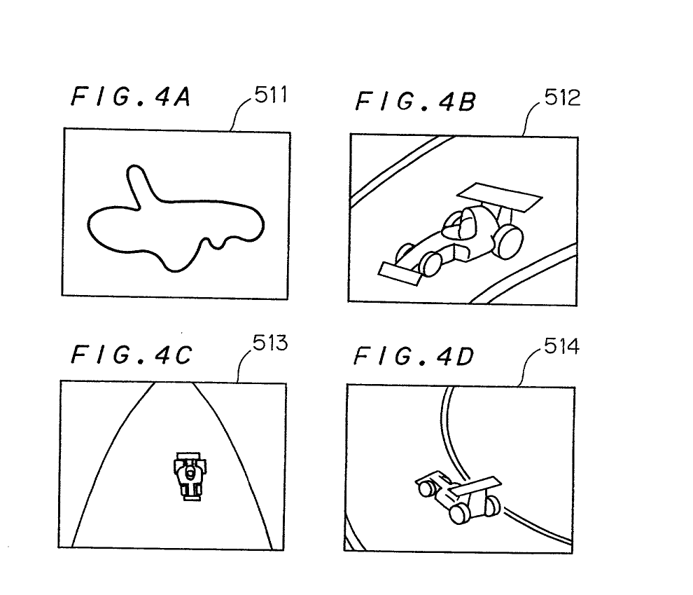

FIGS. 4A through 4D illustrate video pictures 511 to 514 based on the video signals for the first to fourth channels, respectively, generated for an automobile racing program. FIG. 4A shows a CG (computer graphics) video picture of the entire race course or track, and FIGS. 4B through 4D shows video pictures of cars racing in first, second and third places, respectively. In this manner, the transmitter 1 broadcasts the single program by using the plurality of channels.

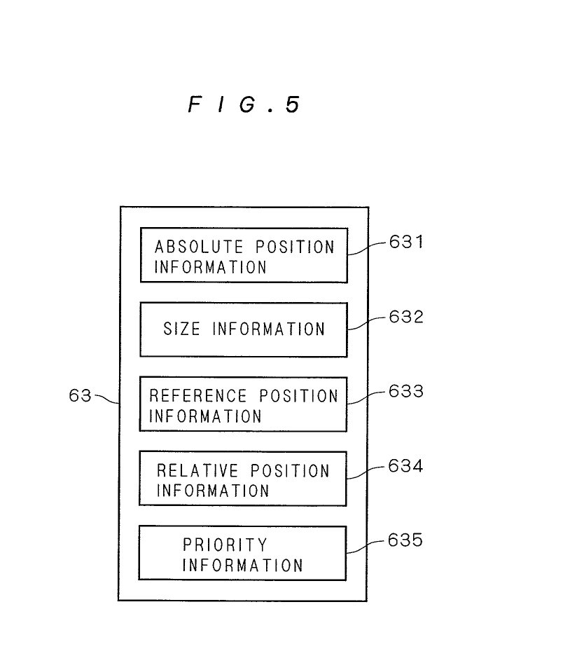

FIG. 5 is a block diagram illustrating a structure of attendant information 63 generated by the attendant information generator circuit 123. The attendant information 63 is used when displaying video pictures for a plurality of channels in combination on the display screen of the receiver 2. The attendant information 63 comprises: absolute position information 631 indicating the display position of a video picture; size information 632 indicating the size of a video picture; reference position information 633 indicating a position used as a reference when combining video pictures; relative position information 634 indicating a position relative to the reference position; and priority information 635 for determining a video picture to be displayed in preference to other video pictures in an overlapping region of a plurality of video pictures when combined.

The absolute position information 631 is used singly as position information about the position of a video picture when displayed on the display screen of the receiver 2, and the relative position information 634 is used as position information by combination with the reference position information. The term “combination of video pictures” used herein shall include not only the process of overlaying a plurality of video pictures one upon another to produce a composite display but also the process of incorporating a video signal in an output signal to display at least one video picture in a predetermined position on the display screen.

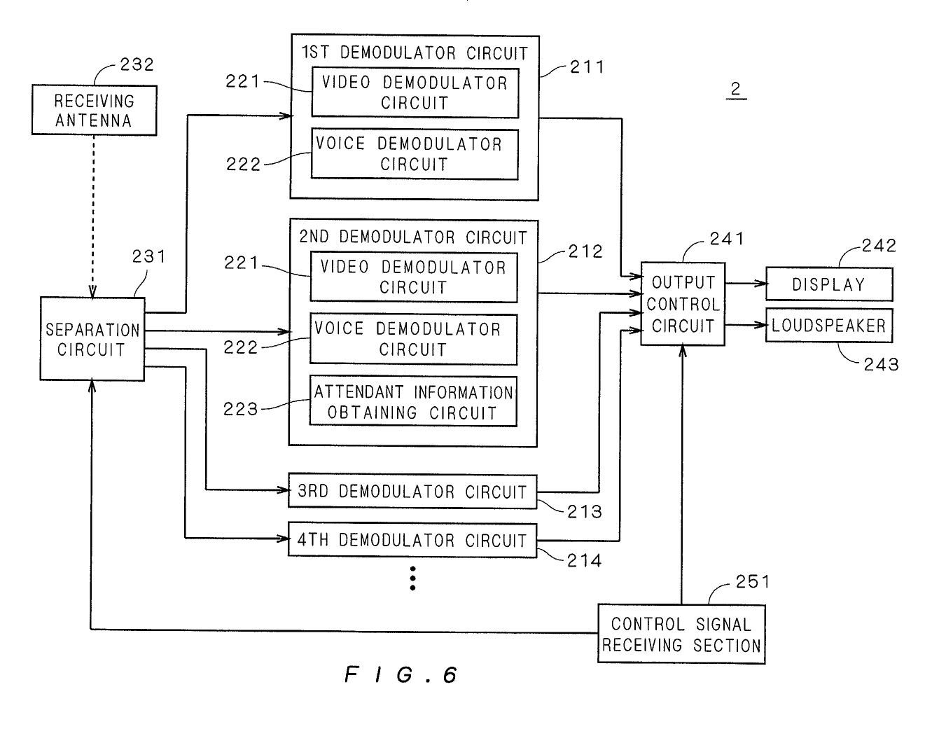

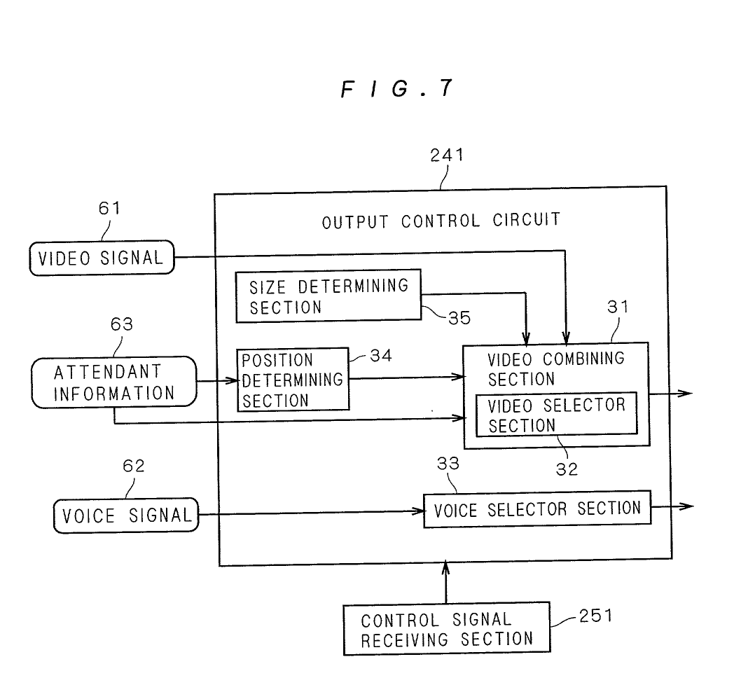

FIG. 6 is a block diagram showing a construction of the receiver 2 in consideration for reception of the broadcast signal from the transmitter 1 shown in FIG. 2. The receiver 2, of course, is capable of receiving a normal broadcast signal.

With reference to FIG. 6, the receiver 2 comprises: a receiving antenna 232 for receiving the broadcast signal; a separation circuit 231 for separating channel signals from the signal provided from the receiving antenna 232; a plurality of demodulator circuits for demodulating the channel signals; an output control circuit 241 for selecting the demodulated video and voice signals and for combining video signals; a display 242 and a loudspeaker 243 for providing outputs to a viewer; and a control signal receiving section 251 for receiving a signal from a remote controller. In FIG. 6, the reference numerals 211, 212, 213 and 214 designate first to fourth demodulator circuits, respectively, among the plurality of demodulator circuits.

The separation circuit 231 selects a program through the control signal receiving section 251 in response to a viewer's manual operation of the remote controller. In the case of so-called multi-angle broadcasting in which one program is broadcasted using a plurality of channels, the separation circuit 231 extracts a plurality of relevant channel signals to individually transfer these signals to the respective demodulator circuits.

Among the plurality of channel signals, the channel signal generated by the first channel signal generator circuit 111 of FIG. 2 does not include the attendant information 63, and is a signal of a video picture to be displayed on the full screen of the display 242. The channel signal which does not include the attendant information 63 is sent to the first demodulator circuit 211, whereas other channel signals which include the attendant information 63 are suitably sent to other demodulator circuits than the first demodulator circuit 211.

The first demodulator circuit 211 comprises a video demodulator circuit 221 and a voice demodulator circuit 222 which generate a video signal and a voice signal, respectively, from the channel signal. Each of the second demodulator circuit 212 and the subsequent demodulator circuits comprises a video demodulator circuit 221, a voice demodulator circuit 222 and an attendant information obtaining circuit 223, and generates the attendant information 63 in addition to the video signal and the voice signal from the channel signal. The video signals, the voice signals and the attendant information generated in the demodulator circuits are sent to the output control circuit 241.

FIG. 7 is a functional block diagram showing a construction of the output control circuit 241. The output control circuit 241 comprises: a video combining section 31 for incorporating a plurality of video pictures in its output signal; a voice selector section 33 for selectively outputting a plurality of voice signals 62; a position determining section 34 for determining the position of combination of video pictures; and a size determining section 35 for determining the size of video pictures to be combined. The video combining section 31 comprises a video selector section 32 for selecting video signals 61.

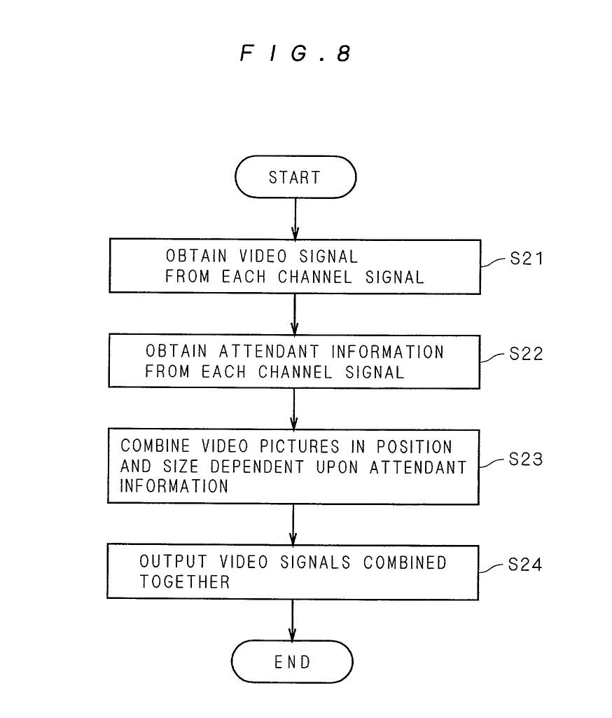

FIG. 8 is a schematic flow diagram showing a video-related operation in the receiver 2. The steps shown in FIG. 8 are performed substantially in parallel during broadcasting, but are shown in the form of a flow diagram for purposes of convenience. First, each of the demodulator circuits obtains the video signal from the channel signal (Step S21). Further, each of the second to subsequent demodulator circuits obtains the attendant information 63 if the channel signal includes the attendant information 63 (Step S22). The video combining section 31 combines the video signals so that a corresponding video picture is displayed in a display position and in a size both dependent upon the details of the attendant information 63 (Step S23). The process of combining the video signals is performed by various techniques in accordance with the details of the attendant information 63 and a viewer's manual operation. Thereafter, the video combining section 31 outputs the video signals combined together to the display 242 which in turn displays the video pictures (Step S24).

For voice, each of the demodulator circuits obtains the voice signal 62 from the channel signal. Then, the plurality of voice signals 62 are inputted to the voice selector section 33. A control signal is transferred from the control signal receiving section 251 to the voice selector section 33 in response to a viewer's manual operation of the remote controller, and the voice selector section 33 switches to a variety of voices, e.g. a voice without commentary, a voice with commentary and a voice in English.

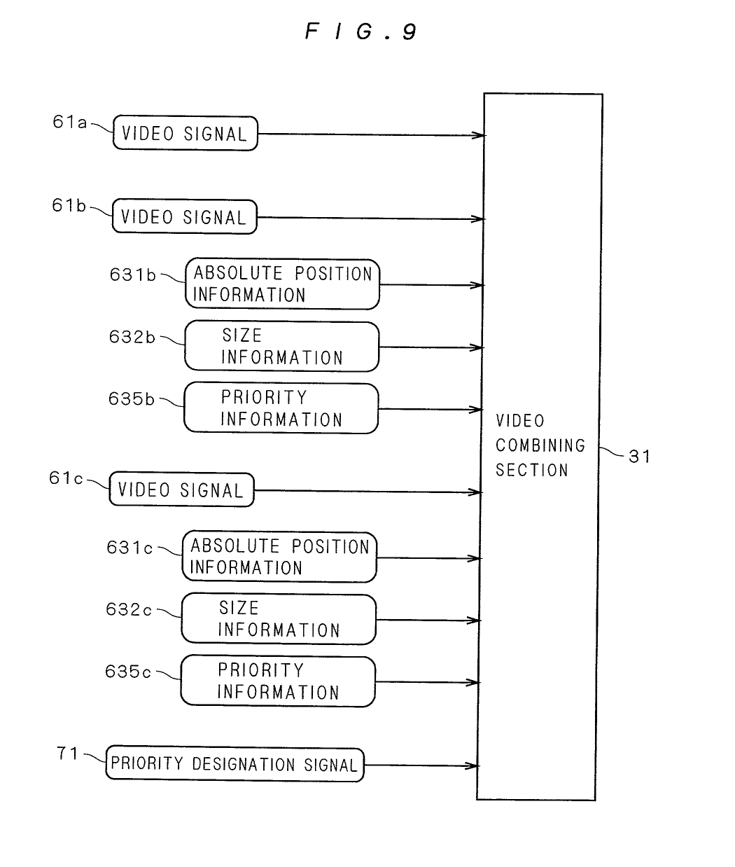

FIG. 9 shows flows of signals and information about video pictures when using the absolute position information 631. With reference to FIG. 9, a video signal 61a is a signal from the first demodulator circuit 211; a video signal 61b, absolute position information 631b, size information 632b and priority information 635b are a signal and attendant information 63 from the second demodulator circuit 212; and a video signal 61c, absolute position information 631c, size information 632c and priority information 635c are a signal and attendant information 63 from the third demodulator circuit 213. Inputs from the fourth and subsequent demodulator circuits are not shown in FIG. 9.

FIG. 10 illustrates video pictures combined together when using the absolute position information 631. In FIG. 10, the video pictures 512 to 514 of first-place to third-place cars are shown as combined with the CG video picture 511 of the entire race course of automobile racing. The absolute position information 631 indicates absolute coordinate values on the screen. In the example of FIG. 10, the coordinate values of the upper-left corner positions 522 to 524 of the respective video pictures 512 to 514 are used as the absolute position information 631. Of course, the position indicated by the absolute position information 631 may be set at the center of each video picture or the like.

The size information 632 indicates the size, i.e. vertical and horizontal dimensions (or the ratio to the display screen), of each of the video pictures 512 to 514. The video combining section 31 overlays the video pictures 512 to 514 on the video picture 511 in predetermined positions and in predetermined sizes, respectively, by reference to the absolute position information 631 and the size information 632.

The coordinate values indicated by the absolute position information 631 are such that each of the video pictures 512 to 514 is displayed in the position of the corresponding car racing along on the actual race course. This achieves the video pictures 512 to 514 moving on the race course displayed in the CG video picture 511 as the race proceeds, thereby allowing a viewer to enjoy the video pictures of the respective cars while viewing the appearance of the cars on the race course. The use of video pictures from on-board cameras as the video pictures 512 to 514 allows the viewer to enjoy the video pictures as viewed along lines of sight similar to those of car drivers and the positional relationship between the cars relative to each other at the same time.

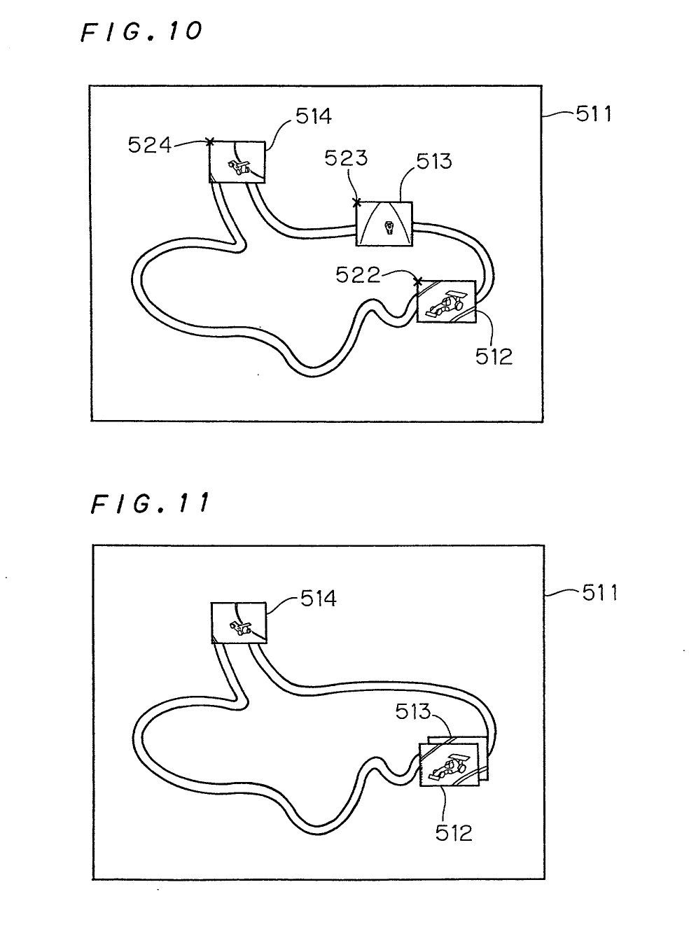

When two or more cars come close to each other in the example shown in FIG. 10, the video pictures 512 to 514 displayed on a reduced scale overlap each other. In such a case, the video combining section 31 judges which video picture is to be displayed in the overlapping region by reference to the priority information 635 associated with the video pictures 512 to 514, to combine the video pictures 512 to 514. As a result, the video picture 512 is displayed in preference to the video picture 513, as illustrated in FIG. 11.

On the other hand, a priority designation signal 71 from the remote controller is inputted through the control signal receiving section 251 to the video combining section 31 so that the viewer can determine display priorities of the overlapping video pictures, as required, independently of the priority information 635. In the example shown in FIG. 11, for instance, if the priority designation signal 71 indicates that the video picture 513 of the second-place car receives the high priority for display, the video picture 512 of the first-place car is hidden behind the video picture 513 of the second-place car when the first-place car and the second-place car are close to each other. In such a case, the viewer can change the display priorities by manual operation so that the video picture 512 of the first-place car is displayed in preference to the video picture 513 of the second-place car as shown in FIG. 11.

As described above, the display priorities may be either included in the broadcast signal or designated by the viewer. The previous determination of the display priorities in either method permits proper control of display of the video pictures which overlap each other.

The absolute position information 631 may include information about the angular position (rotation) of each of the video pictures 512 to 514. The same is true for the relative position information 634 to be described below.

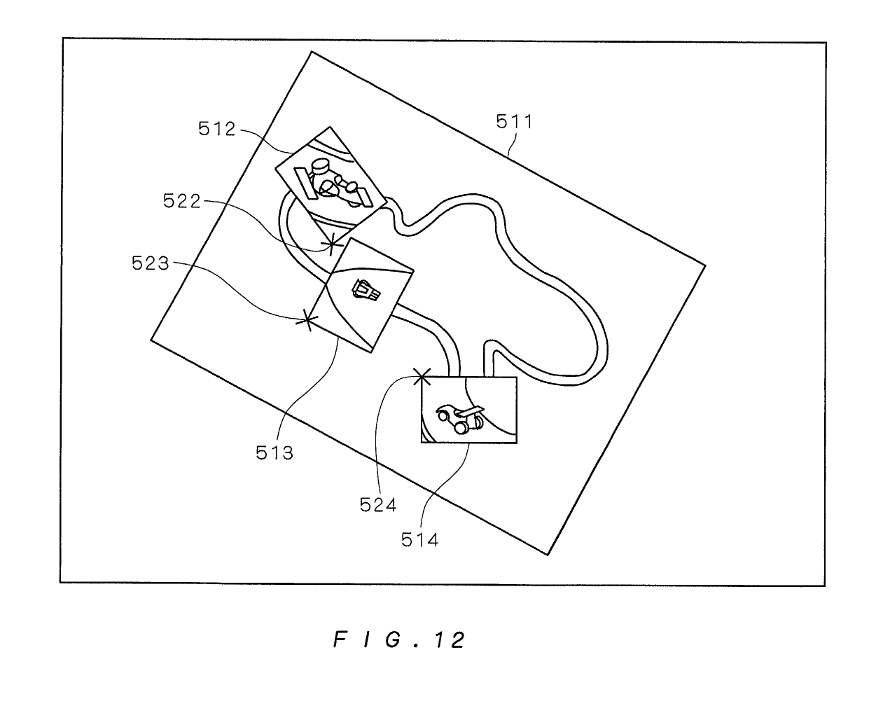

FIG. 12 illustrates the video pictures 512 to 514 displayed in combination with the CG video picture 511 when using the information about rotation. In FIG. 12, the positions 522 to 524 are absolute positions for displaying the video pictures 512 to 514, respectively, with respect to the CG video pictures 511. The video pictures 512 to 514 are displayed after rotated so that the race course and the cars are oriented in line. Additionally, when the viewer watches the video picture 514 with interest, the CG video picture 511 and other video pictures 512, 513 are rotated so that the video picture 514 is in a normal orientation. This allows the viewer to enjoy the racing with a sense of realism more while watching the video picture 514 with interest.

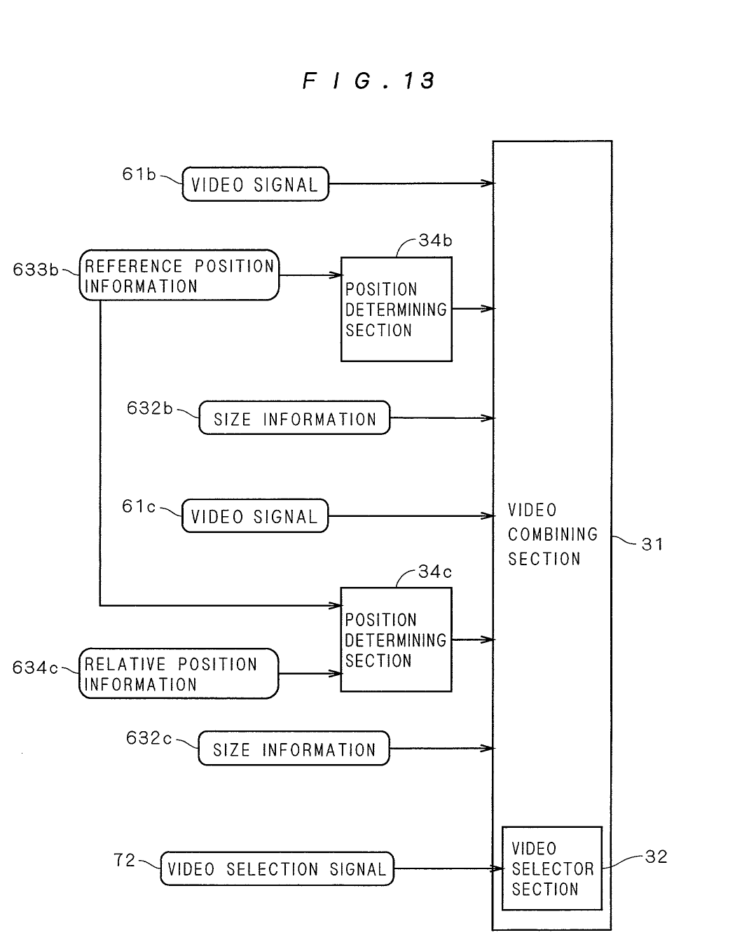

FIG. 13 shows an example of flows of signals and information about video pictures when using the reference position information 633 and the relative position information 634. With reference to FIG. 13, the video signal 61b, reference position information 633b, relative position information 634b and the size information 632b are a signal and attendant information 63 from the second demodulator circuit 212; and the video signal 61c, reference position information 633c, relative position information 634c and the size information 632c are a signal and attendant information 63 from the third demodulator circuit 213. The signal from the first demodulator circuit 211 is not used, and inputs from the fourth and subsequent demodulator circuits are not shown in FIG. 13.

FIG. 14 illustrates video pictures displayed in the case of the flows of the video signals and information shown in FIG. 13. The video pictures in the automobile racing program shown in FIG. 4 are illustrated in FIG. 14. The video pictures 512 to 514 of the cars racing in first to third places are displayed in upper-left, upper-right and lower-left parts of the screen, respectively, and a CG video picture 515 of the entire race course and car positions which is transmitted via a different channel is displayed in a lower-right part of the screen. The video picture 512 corresponds to the video signal 61b, and the video picture 513 corresponds to the video signal 61c.

The reference position information 633 indicates the absolute coordinate values on the screen. In the example of FIG. 14, the coordinate values of the upper-left corner position 532 of the video picture 512 are used as the reference position information 633. The reference position information 633 is included in the attendant information 63 for the video picture 512. The relative position information 634 for the video pictures 513 to 515 indicates the positional relationship of the upper-left corner positions 533 to 535 of the video pictures, respectively, relative to the reference position 532. Although the relative position information 634b is not included in the attendant information 63b in the example shown in FIG. 13, the relative position information 634b indicating that a distance relative to the reference position 532 equals zero may be provided for the video picture 512. The reference position information 633 is not included in the attendant information 63 about the video pictures 513 to 515.

As shown in FIG. 13, the position determining section 34c calculates the position in which each video picture is to be displayed or to be overlaid on the background (which may be black) from the reference position information 633b and the relative position information 634c. This determines the absolute coordinate values of the position 532.

On the other hand, the size information 632 indicates the size, i.e. vertical and horizontal dimensions, of each of the video pictures 512 to 515. The video combining section 31 displays the video pictures 512 to 515 in combination in predetermined positions of the screen and in predetermined sizes, respectively, by reference to the determined absolute coordinate values and the size information 632.

If a change occurs in the places of the cars, the relative position information 634 is changed in the broadcasting station. This properly changes the display positions of the video pictures 512 to 514 in accordance with the places of the cars to maintain constant the relationship between the places of the cars and the display positions. As a result, the viewer can enjoy display which allows the viewer to easily see the video pictures of the respective cars and the places thereof. Thus, the relative position information 634 changes with time in accordance with the contents of the program, and the display positions of the respective video pictures on the screen change in a visual form in accordance with the change in the relative position information 634.

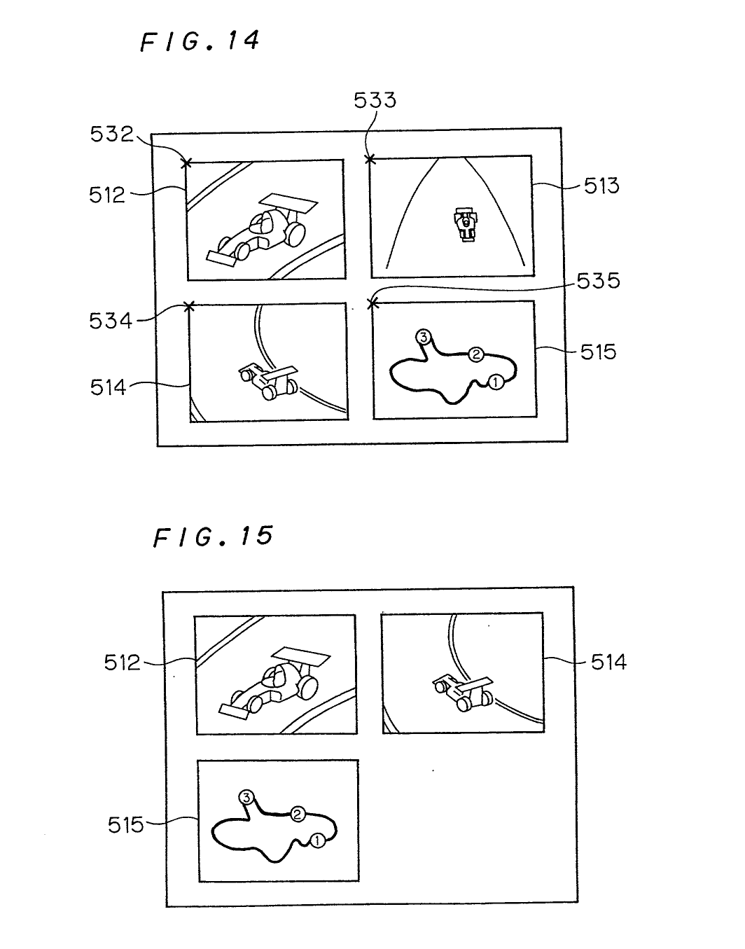

A video selection signal 72 for selecting display/non-display of each of the video pictures is inputted from the remote controller through the control signal receiving section 251 to the video combining section 31, and the video selector section 32 controls the display/non-display of each of the video pictures. FIG. 15 is an example of a display when the video picture 513 shown in FIG. 14 is placed in a non-display state. Placing the video picture 513 in the non-display state as shown in FIG. 15 moves the video picture 514 to the position in which the video picture 513 has been present and moves the video picture 515 to the position in which the video picture 514 has been present. That is, the video selection signal 72 is inputted also to the position determining section 34 (although not shown in FIG. 13) to change the display positions.

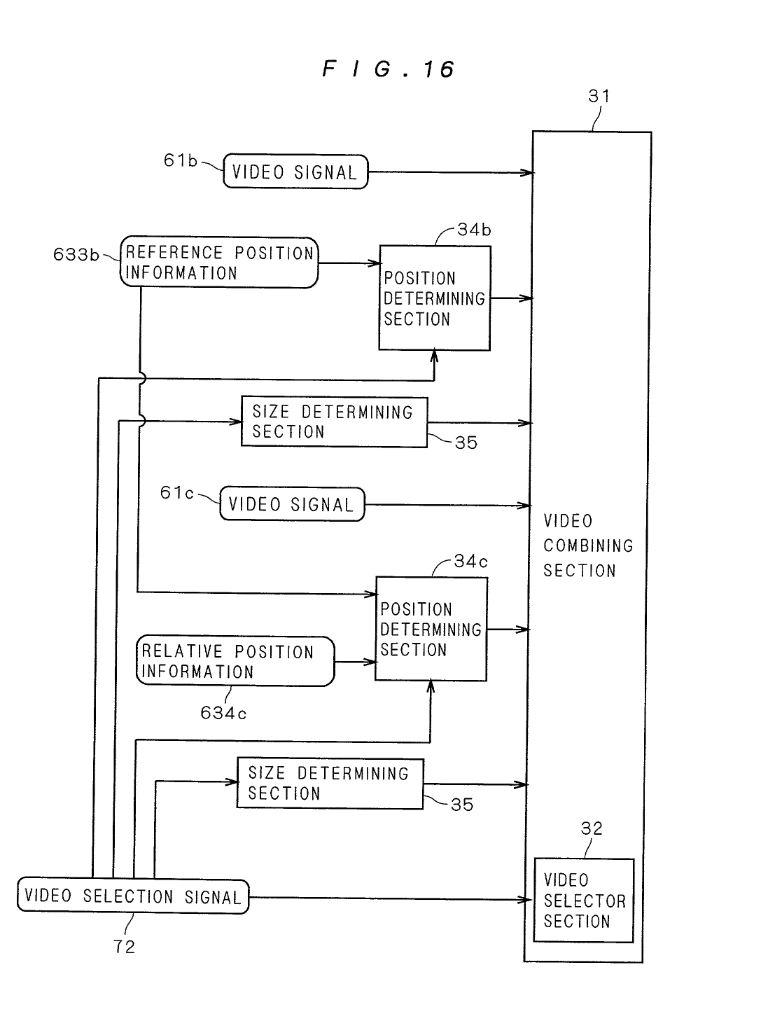

FIG. 16 shows another example of flows of signals and information about the video pictures when using the reference position information 633 and the relative position information 634. FIG. 16 differs from FIG. 13 in that the size information 632 is not used. The components of the attendant information 63 are designated by reference characters identical with those of FIG. 13.

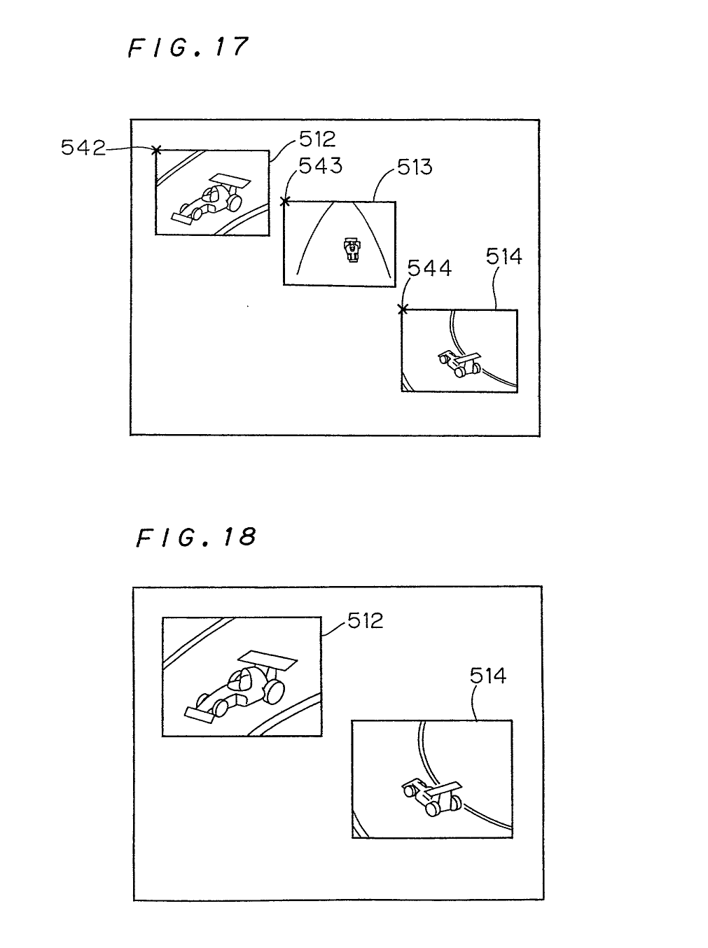

FIG. 17 illustrates the video pictures combined together in the case of the flows of the video signals and information shown in FIG. 16. In FIG. 17, a position 542 is a position indicated by the reference position information 633, and positions 543 and 544 are positions determined by the position determining section 34 from the relative position information 634. As illustrated in FIG. 17, the position of the video picture of each of the cars is determined depending upon the time and distance each car lags behind the first-place car, and the viewer can enjoy display which allows the viewer to easily see the relative positional relationship between the cars on the race course from the display positions of the video pictures 512 to 514.

Referring again to FIG. 16, the video selection signal 72 from the control signal receiving section 251 is inputted to the size determining section 35 which in turn properly determines the size of the video pictures 512 to 514 in accordance with the number of selected video pictures.

FIG. 18 is an example of a display when the viewer operates to place the video picture 513 shown in FIG. 17 in a non-display state. As shown in FIG. 18, when the number of video pictures to be displayed is changed, the size determining section 35 determines a new size of the video pictures. Then, the video pictures are displayed in a proper size dependent on the number of video pictures. The video selection signal 72 is inputted also to the position determining section 34 which in turn modifies the positions of the video pictures relative to each other in accordance with the change in the size of the video pictures.

In the broadcasting of the broadcasting system 10, as described hereinabove, the broadcast signal includes the information indicating the position in which a video picture is to be displayed and the information about the size of the video picture (as required). Therefore, the broadcasting system 10 can control the display positions of a plurality of multilaterally captured video pictures in so-called multi-angle broadcasting to provide a new form of viewing and listening to broadcast programs.

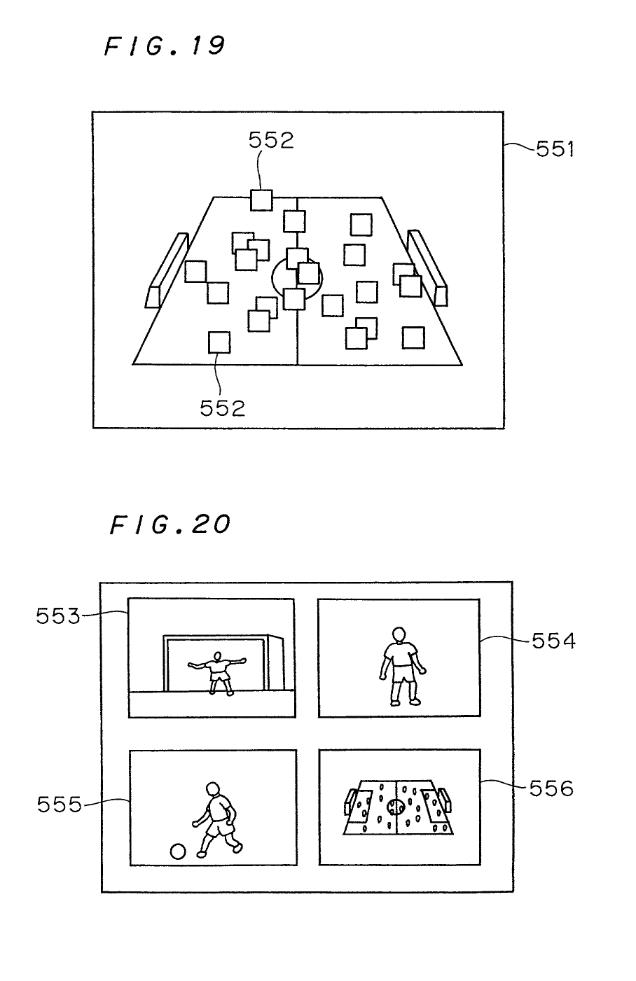

FIGS. 19 through 21 show examples of displays when broadcasting by relay a soccer game program in the broadcasting system 10. In the soccer game program, a video picture of the entire soccer field, video pictures of respective players, a video picture of a goalkeeper, video pictures of benches and the like are used as video pictures for respective channels.

FIG. 19 illustrates video pictures 552 of respective players combined with a CG video picture 551 of the entire soccer field. In this case, the absolute position information 631 and the size information 632 are used to place the video pictures 552 in the positions in which the respective players are present.

FIG. 20 shows a composite display produced after the viewer selects video pictures and the position determining section 34 and the size determining section 35 determine the position and size of each video picture 553 to 556.

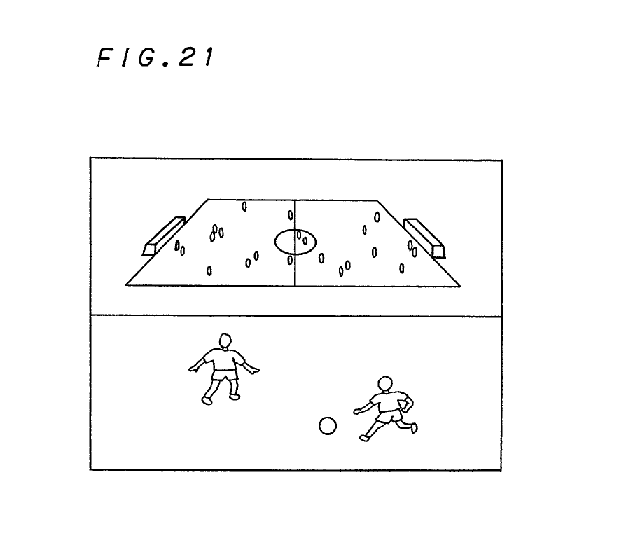

FIG. 21 illustrates a video picture of the entire soccer field and a normal video picture arranged by viewer's selection. As shown in FIG. 21, the size determining section 35 may change the aspect (length-to-width) ratio of the video pictures when determining the size of the video pictures.

The broadcasting system 10 can provide useful forms of viewing and listening to other various programs. For example, when relaying a baseball game, the broadcasting system 10 may transmit a video picture of a entire baseball field and multi-angle video pictures of respective players such as fielders and runners in addition to a normal screen together with the attendant information, thereby to produce a composite display (i.e., a picture-in-picture display) having the video pictures of the respective players in combination with the video picture of the entire baseball field in accordance with the positions of the respective players or to produce a composite display (a picture-in-picture display, a picture overlay display, a picture array display, and the like) depending on viewer's selection. Combining video pictures as viewed along the lines of sight of the respective players with the video picture of the entire baseball field (e.g., placing a video picture of a catcher in the position of a pitcher, or vice versa) allows the viewer to enjoy the video pictures as viewed along the lines of sight of the respective players while seeing the positions of the respective players.

For a relay program of golf, the broadcasting system 10 may transmit a video picture of the entire golf course, a video picture of each party of golfers and the like in addition to a normal screen together with the attendant information, thereby to display the video picture of each party in combination with the video picture of the entire golf course in accordance with the rounds of golf or to produce a composite display depending on viewer's selection.

For a weather forecast program, the broadcasting system 10 may transmit video pictures relayed from respective places and the like in addition to a screen of a map together with the attendant information, thereby to display the video pictures relayed from the respective places in combination with the video picture of the map or to combine a video picture of an area in which the viewer stays with the normal screen.

For a relay program of a concert, the broadcasting system 10 may transmit a video picture of an entire band of performers, a magnified video picture of each part of performers and the like in addition to a normal screen together with the attendant information, thereby to display the video pictures of performers' faces in combination with the video picture of the entire band in accordance with the position of each part, to display a video picture of only a leader in combination with the video picture of the entire band or to produce a composite display depending on viewer's selection.

2. Second Preferred Embodiment

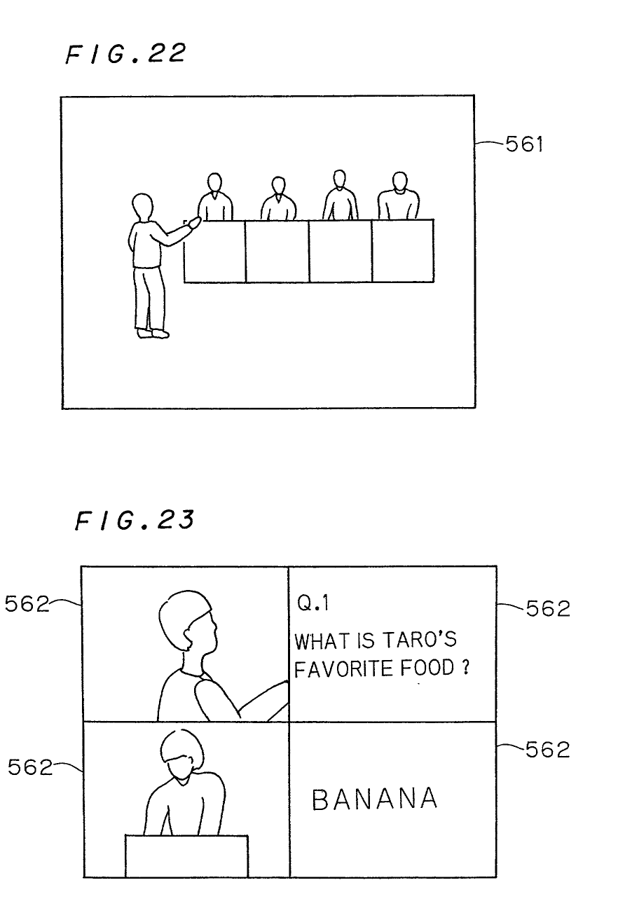

FIGS. 22 and 23 illustrate video pictures broadcasted in the broadcasting system according to a second preferred embodiment of the present invention. The transmitter 1 and the receiver 2 of the broadcasting system of the second preferred embodiment are similar in basic construction to those of FIGS. 2 and 6, and reference numerals and characters identical with those of the first preferred embodiment are used, as required, in the second preferred embodiment.

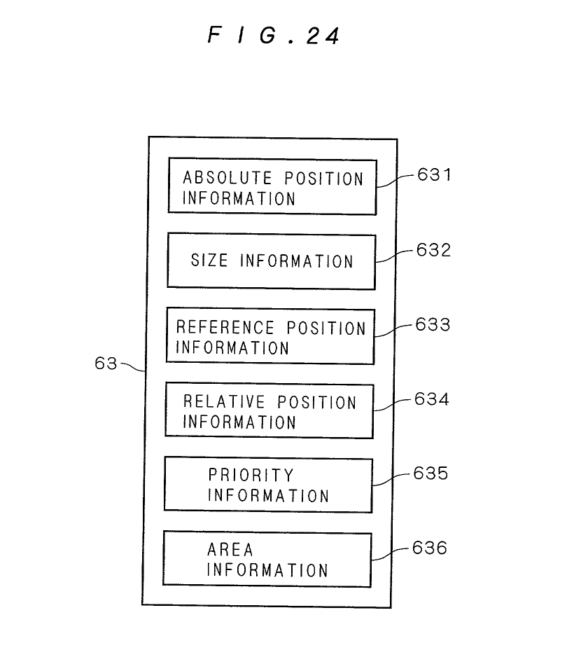

FIG. 22 illustrates a video picture 561 of a normal screen in a quiz program. FIG. 23 illustrates four sub-video pictures 562 combined with a video picture for one channel. FIG. 24 shows a structure of the attendant information 63 attendant on the video picture shown in FIG. 23. The attendant information 63 is provided for each of the sub-video pictures 562 and is constructed such that area information 636 is added to the attendant information 63 of the first preferred embodiment. The area information 636 indicates an area in which a sub-video picture 562 is present in one video picture.

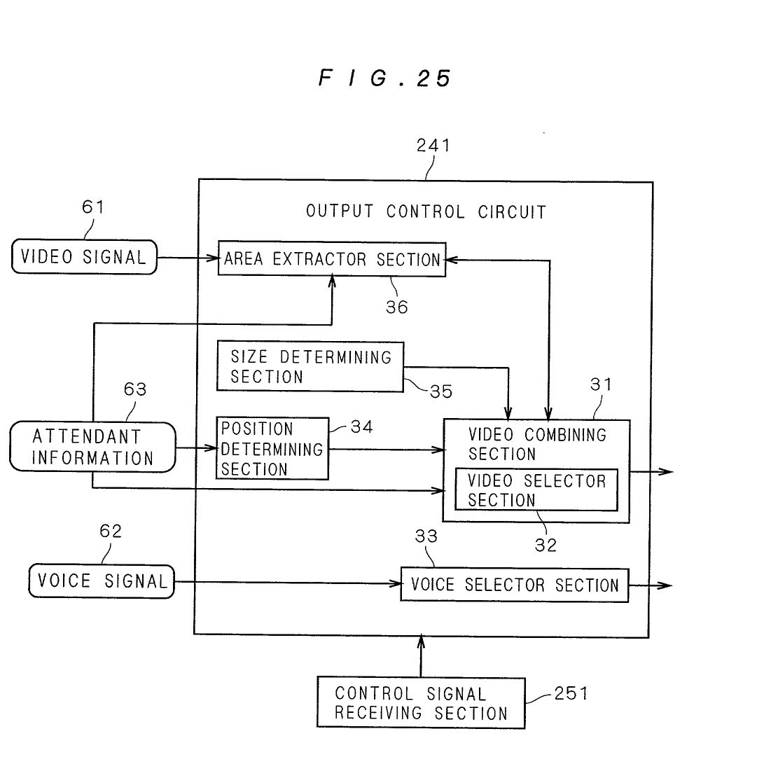

FIG. 25 is a functional block diagram showing the construction of the output control circuit 241 according to the second preferred embodiment. The output control circuit 241 of the second preferred embodiment is substantially similar to that of the first preferred embodiment except that an area extractor section 36 extracts a signal about each sub-video picture 562 from the video signal 61, based on the area information 636 of the attendant information 63.

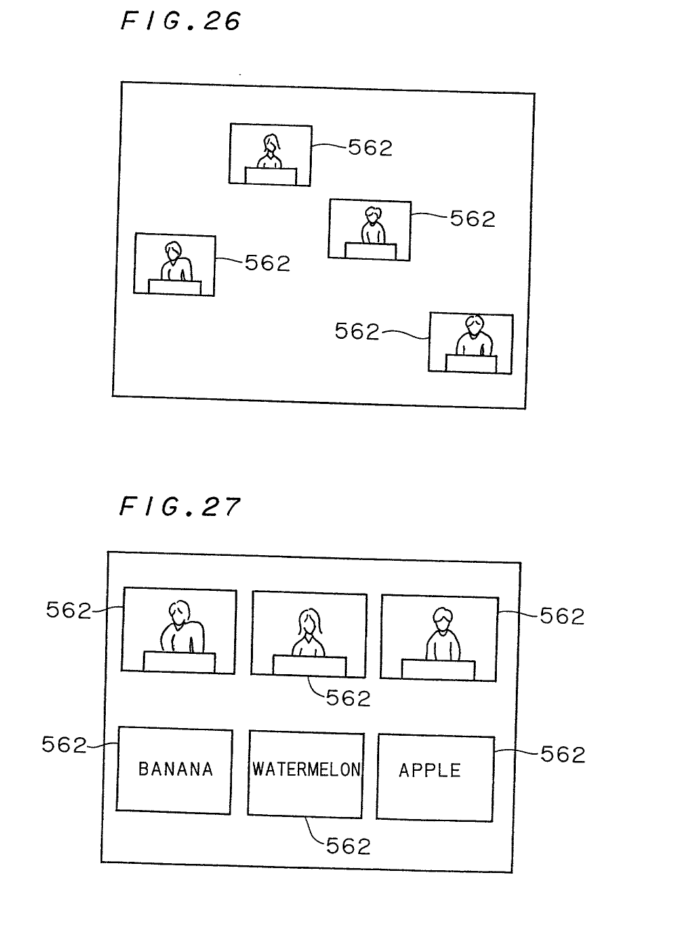

FIG. 26 shows an example of a composite display (a picture array display) of the sub-video pictures 562. The attendant information 63 about each of the sub-video pictures 562 includes the reference position information 633 having absolute coordinate values for displaying a video picture of a corresponding panelist in a lower part of the screen when the panelist scores zero point. The relative position information 634 has relative coordinate values for displaying a video picture of each panelist who scores more points in a higher position on the screen. This achieves a composite display of the sub-video pictures 562 which are video pictures of respective panelists in the size indicated by the size information 632, and vertical movement of the sub-video pictures 562 depending on the points scored by the respective panelists.

Specifically, if a change occurs in the points scored by the panelists, the relative position information 634 is changed in the broadcasting station. This properly changes the display positions of the sub-video pictures 562 depending on the points scored by the panelists. As a result, the viewer can enjoy display which allows the viewer to easily see the video pictures of the respective panelists and the order of points scored by the panelists. Thus, the relative position information 634 changes with time in accordance with the contents of the program, and the display positions of the respective video pictures on the screen change in a visual form in accordance with the change in the relative position information 634.

FIG. 27 shows an example of a display on which a sub-video picture 562 of each panelist and a sub-video pictures 562 of his/her answer are associated with each other. In the example shown in FIG. 27, the position determining section 34 determines the display position of each sub-video picture 562 by the use of the reference position information 633 and the relative position information 634 about each sub-video picture 562, and the size determining section 35 determines the size of the sub-video pictures 562 depending on the number of sub-video pictures 562 to be displayed. This produces a composite display of the sub-video pictures 562, as required.

As described hereinabove, the broadcasting system 10 according to the second preferred embodiment is adapted to incorporate four sub-video pictures in a video picture for one broadcast channel, and to transmit four video pictures (i.e., the sub-video pictures 562) to be displayed in combination via one broadcast channel. As a result, the broadcasting system 10 is required to use only two channels for transmission of eight sub-video pictures, and required to use only three channels for transmission of 12 sub-video pictures. At least two sub-video pictures may be included in one broadcast channel. This achieves the transmission and reception of video pictures the number of which is greater than the number of channels to be used.

3. Modifications

Although the attendant information 63 is included in other channel signals than the channel signal for the first channel in the above-mentioned preferred embodiments, the attendant information 63 may be included also in the channel signal for the first channel or, on the contrary, may be included in only one of the channel signals. Associating the attendant information 63 with at least one video picture allows the control of the position and size of the video picture when displaying the video picture on the display screen of the receiver 2.

Further, the priority information 635 is used to control display when video pictures accompanied by the attendant information 63 overlap each other in the above-mentioned preferred embodiments. However, such a problem does not arise when only one video picture is accompanied by the attendant information 63. Therefore, the priority information 635 is generated only when there are at least two video pictures accompanied by the attendant information 63.

Although the absolute position information 631 is transmitted from the transmitter 1 in the above-mentioned preferred embodiments, the viewer may use the remote controller to designate the absolute position in which video pictures are to be displayed in combination. Similarly, the viewer may determine the reference position by the use of the remote controller. Additionally, the viewer may change the relative position information 634. This allows the viewer to change the position and orientation of a video picture and a distance between video pictures to suit the needs or preferences of the viewer. When the viewer designates the position in which video pictures are to be displayed in combination, the information about the position need not be transmitted from the transmitter 1.

When, as on the screen display illustrated in FIG. 14, the information about the program (the places, e.g. first place and second place, of the cars) and the relative positional relationship between the video pictures are closely related to each other, the information about the program may be used substantially as the relative position information 634 for operation of the positions of the video pictures. Similarly, when the first-place car receives the highest priority for production of a composite display as on the screen display illustrated in FIG. 11, the information about the program may be used substantially as the priority information 635.

In place of the relative position information 634, information indicating the amount of change (or the amount of movement) of the display position of a video picture may be transmitted from the transmitter 1. In this case, the display position is moved in the receiver 2 in accordance with the amounts of change transmitted successively with time.

Although the size of the video picture (or the size ratio thereof to the display screen) when producing a composite display having the video picture is transmitted as the size information 632 in the above-mentioned preferred embodiments, the size information 632 may be of any configuration which substantially indicates the size of the video picture. For example, a substantial video picture may be included only in part of the video picture for one channel signal while the remaining part thereof (background) is black, and the receiver 2 may extract an area in which the substantial video picture is present to obtain the size information.

Further, although the video picture related to one channel signal has a plurality of sub-video pictures 562 in the second preferred embodiment, the area in which the sub-video pictures 562 are present may be of any shape and of any size.

While the invention has been described in detail, the foregoing description is in all aspects illustrative and not restrictive. It is understood that numerous other modifications and variations can be devised without departing from the scope of the invention.

What is claimed is:

1. A transmitter for transmitting a broadcast signal for one program by using a plurality of broadcast channels, said transmitter comprising:
a section for generating program information including information about a plurality of video pictures respectively corresponding to said plurality of broadcast channels;
a section for generating position information about a position in which at least one video picture included among said plurality of video pictures is to be displayed on a display screen of a receiver; and
a section for transmitting said position information together with said program information.

2. The transmitter according to claim 1, wherein
a reference position for displaying said at least one video picture on the display screen of said receiver is previously determined, and
said position information includes information indicating said reference position and a relative position to said reference position.

3. The transmitter according to claim 1, wherein
said section for generating said position information generates position information about a position in which at least two video pictures included among said plurality of video pictures are to be displayed on the display screen of said receiver,
said transmitter further comprising
a section for generating information indicating display priorities of said at least two video pictures for use when said at least two video pictures overlap each other,
wherein said section for transmitting said position information transmits said information indicating said display priorities together with said program information and said position information.

4. The transmitter according to claim 1, wherein
said position information changes with time in accordance with contents of said program.

5. A transmitter for transmitting a broadcast signal for one program by using a plurality of broadcast channels, said transmitter comprising:
a section for generating program information including information about a plurality of video pictures respectively corresponding to said plurality of broadcast channels;
a section for generating size information about a size in which at least one video picture included among said plurality of video pictures is to be displayed on a display screen of a receiver; and
a section for transmitting said size information together with said program information.

6. A transmitter for transmitting a broadcast signal for a program, said transmitter comprising:
a section for generating program information including a video signal having a plurality of sub-video signals;
a section for generating area information indicating an area in which each of said sub-video signals is present in said video signal; and
a section for transmitting said area information together with said program information.

7. The transmitter according to claim 6, wherein
said area information changes with time in accordance with contents of said program.

8. A receiver for receiving a broadcast signal for one program using a plurality of broadcast channels, said receiver comprising:
a section for obtaining from said broadcast signal a plurality of video pictures respectively corresponding to said plurality of broadcast channels;
a section for obtaining position information about a position in which at least one video picture included among said plurality of video pictures is to be displayed on a display screen; and
a section for displaying said at least one video picture on said display screen in accordance with said position information.

9. The receiver according to claim 8, wherein
said position information includes a reference position and a relative position to said reference position for displaying said at least one video picture on said display screen.

10. The receiver according to claim 8, wherein
at least two video pictures are displayed in accordance with said position information, and
said at least two video pictures are displayed in accordance with predetermined priorities thereof when said at least two video pictures overlap each other.

11. The receiver according to claim 8, further comprising
a section for accepting selection between display and non-display of each said at least one video picture.

12. The receiver according to claim 11, further comprising
a section for determining the size of a video picture selected to display from said at least one video picture in accordance with the number of video pictures selected to display.

13. The receiver according to claim 8, wherein
said section for obtaining said position information obtains said position information from said broadcast signal.

14. The receiver according to claim 8, wherein
said section for obtaining said position information obtains said position information designated by a user's manual operation.

15. The receiver according to claim 8, wherein
said position information changes with time in accordance with contents of said program.

16. A receiver for receiving a broadcast signal for one program using a plurality of broadcast channels, said receiver comprising:
a section for obtaining from said broadcast signal a plurality of video pictures respectively corresponding to said plurality of broadcast channels;
a section for obtaining size information about a size in which at least one video picture included among said plurality of video pictures is to be displayed on a display screen; and
a section for determining the size of said at least one video picture on said display screen in accordance with said size information.

17. The receiver according to claim 16, wherein
said section for obtaining said size information obtains said size information from said broadcast signal.

18. The receiver according to claim 16, wherein
said section for obtaining said size information obtains said size information designated by a user's manual operation.

19. A receiver for receiving a broadcast signal for a program, said receiver comprising:
a section for obtaining from said broadcast signal a video signal having a plurality of sub-video signals;
a section for obtaining area information indicating an area in which each of said sub-video signals is present in said video signal; and
a section for obtaining said plurality of sub-video signals based on said area information.

20. The receiver according to claim 19, wherein
said section for obtaining said area information obtains said area information from said broadcast signal.

21. A broadcasting system for broadcasting one program by using a plurality of broadcast channels, said broadcasting system comprising:
a transmitter for transmitting a broadcast signal; and
a receiver for receiving said broadcast signal,
said transmitter comprising:
a section for generating program information including information about a plurality of video pictures respectively corresponding to said plurality of broadcast channels;
a section for generating attendant information about a position and/or a size in which at least one video picture included among said plurality of video pictures is to be displayed on a display screen of said receiver; and
a section for transmitting said attendant information together with said program information,
said receiver comprising:
a section for obtaining said plurality of video pictures from said broadcast signal;
a section for obtaining said attendant information from said broadcast signal;
and
a section for displaying said at least one video picture on said display screen in accordance with said attendant information.

22. A method of broadcasting one program by using a plurality of broadcast channels, said method comprising the steps of:
generating program information including information about a plurality of video pictures respectively corresponding to said plurality of broadcast channels; and
generating attendant information about a position and/or a size in which at least one video picture included among said plurality of video pictures is to be displayed on a display screen of a receiver; and
transmitting said attendant information together with said program information.
